(19) United States
(12) Patent Application Publication
(10) Pub. No.: US 2026/0079683 A1
(43) Pub. Date: Mar. 19, 2026

(54) Transforming Code Modules To Different Programming Languages

(71) Applicant: Oracle International Corporation, Redwood Shores, CA (US)

(72) Inventor: Michael Sassin, Andover, MA (US)

(73) Assignee: Oracle International Corporation, Redwood Shores, CA (US)

(21) Appl. No.: 19/325,935

(22) Filed: Sep. 11, 2025

Related U.S. Application Data
(60) Provisional application No. 63/694,466, filed on Sep. 13, 2024.

(51) Int. Cl. G06F 8/51

(52) U.S. Cl. CPC G06F 8/51

(57) ABSTRACT

Techniques for transforming code modules to different programming languages are disclosed. A system accesses a first non-code representation of a first code module expressed in a first programming language and parses the first non-code representation to identify a nested data element of the first non-code representation that represents a nested expression of the first code module. The system executes a transformation technique to transform the nested data element, in the first non-code representation, to a first non-nested data element in the first non-code representation. The system modifies the first non-code representation based on one or more attributes of a second programming language to generate a second non-code representation suitable for representing code modules in the second programming language. The system generates a second code module based at least on the second non-code representation.

### INCORPORATION BY REFERENCE; DISCLAIMER

The following application is hereby incorporated by reference: application No. 63/694,466, filed on Sep. 13, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to transforming code modules from a first programming language to a second programming language. More particularly, the present disclosure relates to transforming database interaction code modules from a first programming language to a second programming language.

### BACKGROUND

Database applications are designed to interact with databases to retrieve, manipulate, and manage data. Database applications may serve as an interface for users and/or other systems to interact with databases. In one example, a database application may perform operations associated with data entry, reporting, and/or analytics. Additionally, or alternatively, database application may handle complex data processing tasks such as Extract, Transform, Load (ETL) operations. In ETL processes, the database application extracts data from various sources, transforms the data into a suitable format or structure, and then loads the data into a target database for storage and analysis. Examples of database applications include business intelligence systems, enterprise resource planning systems, customer relationship management systems, and data warehousing systems.

Database applications include application code modules and database interaction code modules. Application code modules includes general-purpose code associated with various aspects of handle business processes, workflows, and user interactions. Database interaction code modules include code associated with database-related tasks, such as ETL operations, querying, updating, or modifying data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrate example operations associated with transforming database interaction code modules from a first programming language to a second programming language;

FIG. 3 illustrates features of an example machine learning (ML) system in accordance with one or more embodiments;

FIG. 4 is a flowchart that depicts example operations of an ML system in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE SYSTEM ARCHITECTURE
3. EXAMPLE OPERATIONS FOR TRANSFORMING DATABASE
INTERACTION CODE MODULES
4. EXAMPLE EMBODIMENTS
5. EXAMPLE MACHINE LEARNING SYSTEM
6. EXAMPLE COMPUTER NETWORKS
7. HARDWARE OVERVIEW
8. MISCELLANEOUS; EXTENSIONS

### 1. GENERAL OVERVIEW

One or more embodiments identify and remove nested elements within code modules prior to transforming the code modules from a first programming language to a second programming language. In one example, a system transforms code modules, such as database interaction modules, from a programming language that utilizes nested expressions to a programming language that does not utilize nested expressions. To transform a code module, the system identifies a nested expression in the code module and generates a new code module that utilizes a set of one or more non-nested expressions that are functionally equivalent to the nested expression. In one example, the set of one or more non-nested expressions includes one or more flat expressions. In one example, the first programming language is Structured Query Language (SQL), and the second programming language is Oracle® LoCode for Fusion Data Intelligence (LoCode).

In one example, the system transforms multiple code modules of a database application from a first programming language (e.g., SQL) that includes nested expressions to a second programming language (e.g., LoCode) that does not utilize nested expressions. The system generates a syntax tree for the database application and parses the syntax tree to identify nested expressions. When the system identifies a nested expression, the system transforms the nested expression into a set of one or more non-nested expressions that are functionally equivalent to the nested expression. The nested expression is in the first programming language, and the set of one or more non-nested expressions are in the second programming language.

The system may utilize a first set of one or more pre-determined transformation techniques to transform a nested expression into a non-nested expression. In one example, the system utilizes a JOIN expression or a semi-JOIN expression to transform a nested expression into a non-nested expression. Additionally, or alternatively, the system may transform a statement that includes a JOIN or semi-JOIN within a nested subexpression into a set of non-nested expressions. The set of non-nested expression may include a first subset of non-nested expression corresponding to the nested subexpression and a second subset of non-nested expression that joins a result of the first subset of non-nested expressions. Additionally, or alternatively, when the system identifies a non-nested expression, the system transforms the non-nested expression from the first programming language to a second programming language. The system may utilize a second set of one or more pre-determined transformation techniques to transform a non-nested expression from the first programming language into the second programming language. In one example, the system utilizes an expression mapping table to transform a non-nested expression from the first programming language into the second programming language. In one example, the system utilizes an ML model to select transformation techniques for transforming code modules and/or to transform code modules utilizing selected transformation techniques.

In one example, the system utilizes a naming convention when transforming code modules from the first programming language into the second programming language. The naming convention ensures that different operands within a code module and/or within a set of code modules of a database application have unique names. The unique names avoid collisions within the second programming language, for example, in the event that the second programming language has a flat namespace. The flat namespace may imply that multiple expressions with the same name are be treated as the same expression. Additionally, or alternatively, the naming convention ensures that a particular operand has a consistent name within a code module and/or within a set of code modules of a database application.

One or more embodiments described in this Specification and/or recited in the claims may not be included in this General Overview section.

### 2. EXAMPLE SYSTEM ARCHITECTURE

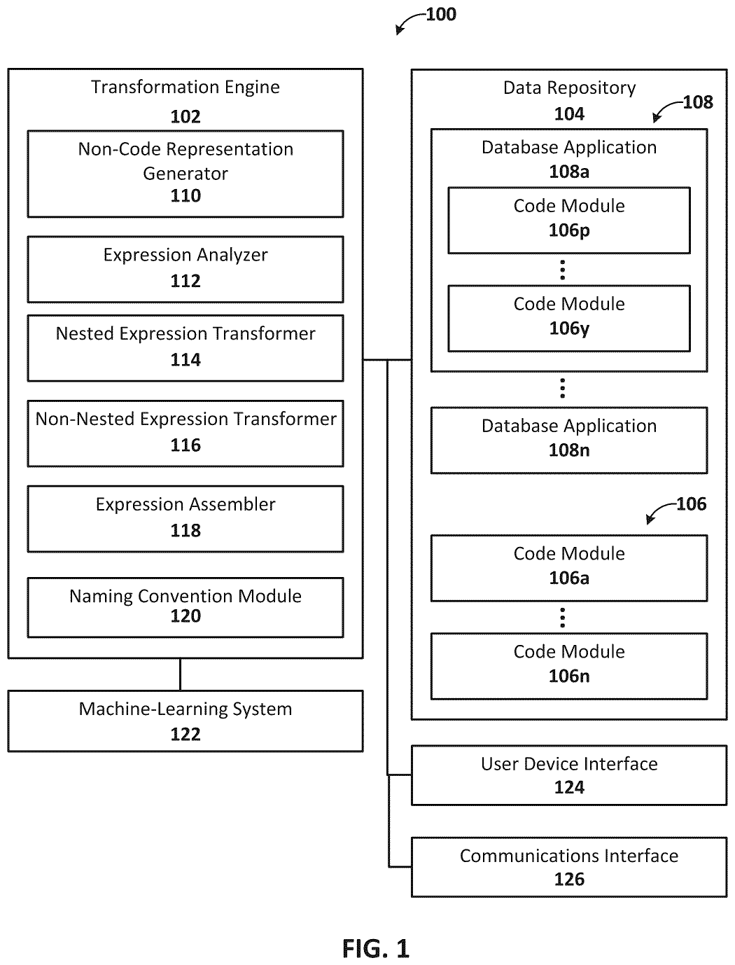

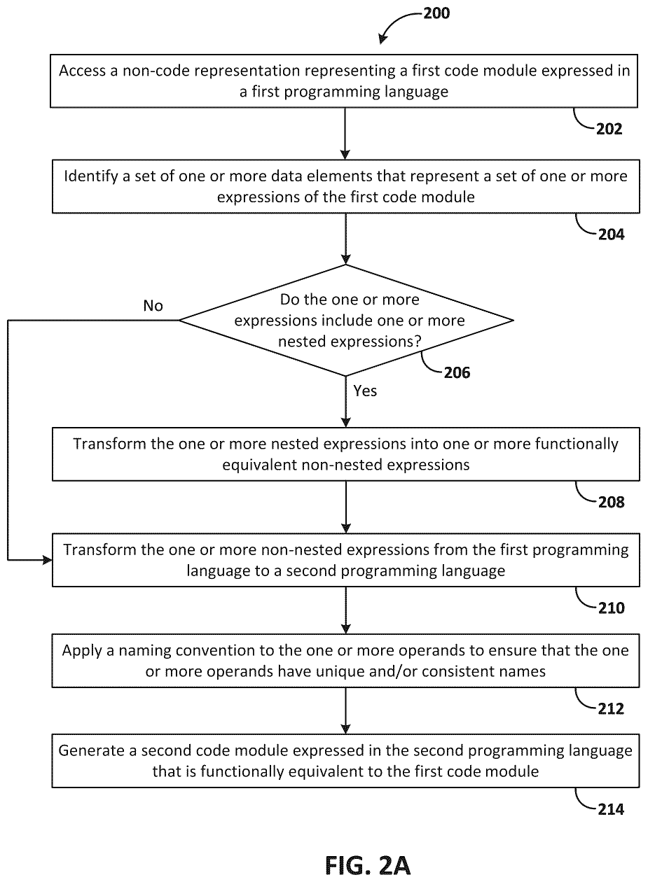

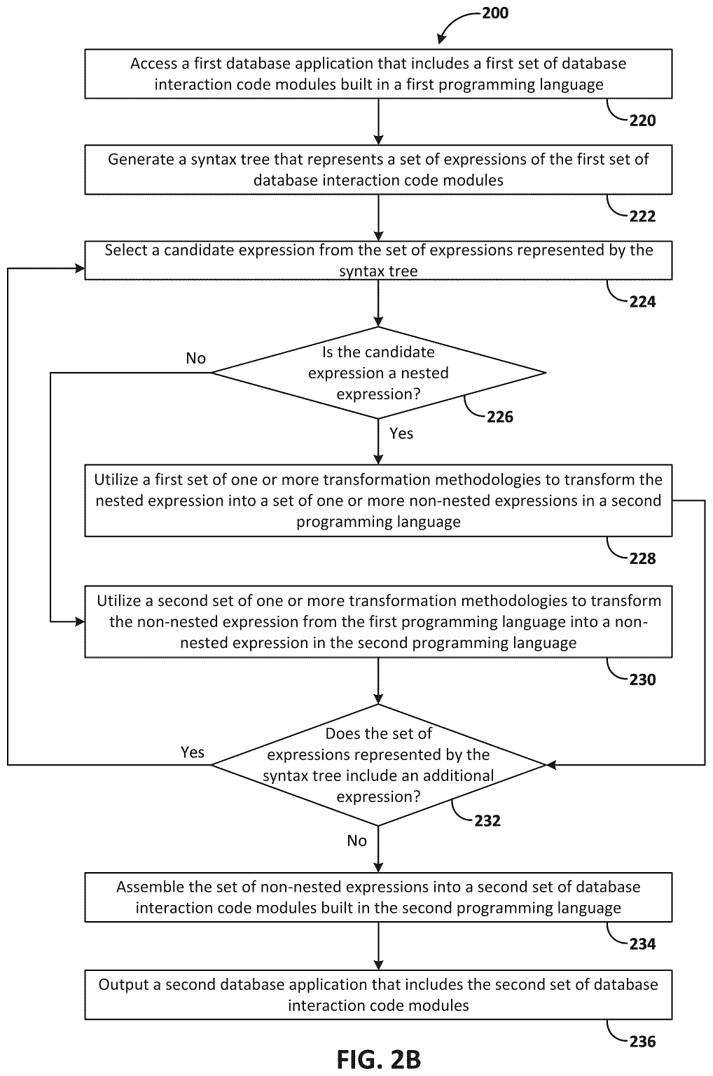

FIG. 1 illustrates features of an example system 100 in accordance with one or more embodiments. The system 100 may execute operations associated with transforming code modules from a first programming language to a second programming language. In one or more embodiments, the system 100 refers to hardware and/or software configured to perform operations described herein. Examples of operations are described below with reference to FIGS. 2A and 2B.

As shown in FIG. 1, the system 100 includes a transformation engine 102 and one or more data repositories 104. The one or more data repositories 104 include code modules 106 and/or database applications 108 that include one or more code modules 106. The transformation engine transforms the code modules 106 and/or the database applications 108 from a first programming language to a second programming language. The one or more data repositories 104 may store code modules 106 and/or database applications 108 to be transformed by the transformation engine 102. Additionally, or alternatively, the one or more data repositories 104 may store code modules 106 and/or database applications 108 that have been transformed by the transformation engine 102. As shown in FIG. 1, the one or more data repositories 104 includes a set of code modules 106, such as code module 106a and code module 106n. Code module 106a may be represented in a first programming language such as SQL. Code module 106a may be awaiting transformation by the transformation engine 102 from the first programming language to the second programming language. Code module 106n may be represented in a second programming language such as LoCode. The transformation engine 102 may have transformed code module 106n from the first programming language into the second programming language. As further shown in FIG. 1, the one or more data repositories 104 may include a set of database applications 108, such as database application 108a and database application 108n. A database application 108 may include one or more code modules. For example, database application 108a includes code module 106p and code module 106y. Database application 108a may be represented in a first programming language such as SQL. Database application 108a, including code module 106p and code module 106y, may be awaiting transformation by the transformation engine 102 from the first programming language into the second programming language. Database application 108n may be represented in a second programming language such as LoCode. The transformation engine 102 may have transformed database application 108n from the first programming language into the second programming language. In one example, the one or more data repositories 104 may include training data for training one or more ML models to execute operations associated with transforming code modules and/or database applications to different programming languages.

In one or more embodiments, a data repository includes any type of storage unit and/or device (e.g., a file system, database, collection of tables, or any other storage mechanism) for storing data. Furthermore, a data repository may include multiple different storage units and/or devices. The multiple different storage units and/or devices may or may not be of the same type or located at the same physical site. Furthermore, a data repository 104 may be implemented or executed on the same computing system as the transformation engine 102. Additionally, or alternatively, a data repository 104 may be implemented or executed on a computing system separate from the transformation engine 102. The one or more data repositories 104 may be communicatively coupled to the transformation engine 102 via a direct connection or via a network.

As shown in FIG. 1, the transformation engine 102 includes a syntax tree generator 110, an expression analyzer 112, a nested expression transformer 114, a non-nested expression transformer 116, an expression assembler 118, and a naming convention module 120. The syntax tree generator 110 generate a non-code representations, such as syntax trees or other data structures, that represent code modules 106 and/or database applications 108. The expression analyzer 112 analyzes the non-code representations to identify data elements for transformation from the first programming language into the second programming language. The non-code representations analyzed by the expression analyzer 112 may be generated by the non-code representation generator 110 or by an external source. The expression analyzer 112 may access a non-code representation representing one or more first code modules 106 and parse the non-code representation to identify data elements of the non-code representation that represent expressions of code modules 106. The expression analyzer 112 may execute a static analysis of a data element to determine a functionality of one or more expressions represented by the data element. The data elements may represent nested expressions or non-nested expressions.

The transformation engine 102 may utilize the nested expression transformer 114 to transform a nested expression represented in the first programming language to a non-nested expression represented in the second programming language. In one example, based at least in part on the functionality of a data element, the nested expression transformer 114 selects at least one transformation technique from a set of multiple pre-determined transformation techniques to transform a nested data element representing a nested expression to a non-nested data element representing a non-nested expression for performing the functionality. After selecting a transformation technique, the nested expression transformer 114 executes the selected transformation technique to transform the nested data element to the non-nested data element. After transforming the nested data element to the non-nested data element, the nested expression transformer 114 converts the non-nested data element from the first programming language into the second programming language.

The transformation engine 102 may utilize the non-nested expression transformer 116 to transform a non-nested expression represented in the first programming language to a non-nested expression represented in the second programming language. In one example, based at least in part on the functionality of a data element, the nested expression transformer 114 selects at least one transformation technique from a set of multiple pre-determined transformation techniques to transform a non-nested data element from the first programming language into the second programming language. After selecting a transformation technique, the nested expression transformer 114 executes the selected transformation technique.

After transforming data elements in the non-code representation, the transformation engine 102 utilizes the expression assembler 118 to assemble expressions represented by the data elements into code modules 106 expressed in the second programming language. The transformation engine 102 utilizes the naming convention module 120 to apply one or more naming conventions. The one or more naming conventions ensure that different operands within a code module 106 and/or within a set of code modules 106 of a database application 108 have unique names. Additionally, or alternatively, the one or more naming conventions ensure that a particular operand has a consistent name within a code module 106 and/or within a set of code modules 106 of a database application 108.

As shown in FIG. 1, the system 100 includes a machine learning system 122. The ML system 122 includes one or more ML models. The one or more ML models are trained based on training data, for example, from the one or more data repositories 104. In one example, the ML system 122 performs one or more operations described with reference to FIG. 2A and/or FIG. 2B. Example components of the ML system 122 are further described below in Section 5, titled “Example Machine Learning System.”

In one example, the one or more ML models may select a transformation technique to transform a code module from a first programming language to a second programming language. Additionally, or alternatively, the one or more ML models may transform a code module from a first programming language to a second programming language. In one example, the transformation engine 102 provides an input prompt to an ML model. The input prompt includes a first code module expressed in a first programing language. The ML model generates a second code module expressed in a second programming language that is functionally equivalent to the first code module.

In one example, an ML model is trained to select transformation techniques for transforming nested expressions into non-nested expressions. The transformation engine 102 may generate an input element that includes a nested data element and direct the input element to the ML model. The ML model executes one or more inferences in response to the input element. The one or more inferences include selecting the transformation technique based at least in part on the functionality of the nested expression. The ML model may generate an output element based at least in part on the transformation technique. The output element may include the transformation technique. Additionally, or alternatively, the ML model may generate the output element based at least in part on the transformation technique. In one example, the one or more inferences include executing the transformation technique to transform the nested data element to a non-nested data element representing a non-nested expression. The output element may include a first non-nested data element. Additionally, or alternatively, the one or more inferences may include converting a first non-nested data element expressed in the first programming language to a second non-nested data element representing a second non-nested expression expressed in the second programming language. The output element may include the second non-nested data element. Additionally, or alternatively, the one or more inferences may include generating a code module that includes a non-nested expression represented by a non-nested data element. The output element may include the code module.

The system 100 may include a user device interface 124 communicatively coupled or couplable with one or more other components of the system 100. A user device interface 124 may include hardware and/or software configured to facilitate interactions between a user and various components of the system 100. The user device interface 124 may render user interface elements and receive input via user interface elements. For example, the user device interface 124 may display outputs generated by the system 100. Additionally, or alternatively, the user device interface 124 may be configured to provide inputs to the system 100. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by a user device interface 124.

In an embodiment, different components of a user device interface 124 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface 124 may be specified in one or more other languages, such as Java, C, or C++.

Additionally, or alternatively, the system 100 may include one or more communications interfaces 126 communicatively coupled or couplable with one or more components of the system 100. The one or more communications interfaces 126 may include hardware and/or software configured to transmit data between respective components of the system 100 and/or to transmit data to and/or from the system 100.

In one or more embodiments, the system 100 may include more or fewer components than the components illustrated in FIG. 1. In one example, the system described with reference to FIG. 1 may include one or more features described below in Section 5, titled “Example Machine Learning System,” Section 6, titled “Example Computer Networks,” and/or Section 7, titled “Hardware Overview.” The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one example, the system 100 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

### 3. EXAMPLE OPERATIONS FOR TRANSFORMING DATABASE INTERACTION CODE MODULES

Referring to FIGS. 2A and 2B, example operations 200 associated with transforming code modules and/or database applications to different programming languages are further described. One or more operations 200 described with reference to FIGS. 2A and 2B may be modified, combined, rearranged, or omitted. Accordingly, the particular sequence of operations 200 described with reference to FIGS. 2A and 2B should not be construed as limiting the scope of one or more embodiments. In one example, the operations 200 may be performed by the one or more components of the system described herein.

A. Transforming Code Modules from a First Programming Language to a Second Programming Language

As described with reference to FIG. 2A, the system transforms a first code module built in a first programming language to a second code module built in a second programming language and that is functionally equivalent to the first code module. The first code module includes one or more nested expressions, and the second code module utilizes one or more non-nested expressions in place of the one or more nested expressions.

As shown in FIG. 2A, the system accesses a non-code representation representing a first code module expressed in a first programming language (Operation 202). The non-code representation may include a syntax tree or other data structure that represents a set of expressions of one or more code modules. The system may access the non-code representation in a data repository. In one example, the system receives a request to transform a code module. The request identifies the code module to be transformed. Additionally, or alternatively, the request may include the code module to be transformed. The request may be provided to the system in response to an input, such as from a user device interface and/or from another computing application.

After accessing the non-code representation, the system identifies a set of one or more data elements that represent a set of one or more expressions, respectively, of the first code module (Operation 204). The system may identify the one or more expressions by parsing the non-code representation, for example, as described below with reference to FIG. 2B. The set of one or more expressions may include one or more nested expressions and/or one or more non-nested expressions.

The system determines whether the one or more expressions include one or more nested expressions (Operation 206). The system may determine whether an expression is a nested expression or a non-nested expression by analyzing a structure of the expression. The system may evaluate the expression to determine whether the expression includes one or more sub-expressions embedded within an outer expression. In one example, the system analyzes the syntax of an expression to determine wither the expression includes one or more sub-expressions embedded within an outer expression.

In a nested expression, at least one part of the expression depends on, or refers to, another sub-expression. For example, the following SQL statement includes a nested expression:

| | |
|---|---|
| (1) | SELECT * |
| | FROM Employees |

WHERE Salary=(SELECT MAX (Salary) FROM Salaries).

In statement (1), the subquery “(SELECT MAX (Salary) FROM Salaries)” is nested inside the WHERE clause of the outer query. The system recognizes that this subquery is embedded in the outer expression.

In a non-nested expression, respective expressions are standalone with no other expressions or subqueries embedded within an outer expression. For example, the following SQL statement includes non-nested expressions:

| | |
|---|---|
| (2) | SELECT * |
| | FROM Employees |
| | WHERE Salary > 50000. |

In statement (2), none of the expressions depend on a subexpression, nor do they refer to another sub-expression. The system recognizes that the statement includes non-nested expressions.

When the system determines that the one or more expressions include one or more nested expressions, the system transforms the one or more nested expressions into one or more functionally equivalent non-nested expressions (Operation 208). In one example, when the system identifies a nested data element in the non-code representation representing a nested expression, the system executes a static analysis of the nested data element to determine a functionality of the nested expression. Based at least in part on the functionality of the nested expression, the system selects at least one transformation technique from a set of multiple transformation techniques to transform the nested data element. In one example, the system transforms the nested data element into a first non-nested data element representing a first non-nested expression, expressed in the first programming language, for performing the functionality. After transforming the nested data element into the first non-nested data element, the system converts the first non-nested data element to a second non-nested data element representing a second non-nested expression expressed in a second programming language.

To select a transformation technique based at least in part on the functionality of the nested expression, the system identifies a first function in the nested data element and selects a transformation technique for transforming the first function to a second function, expressed in the second programming language, that is functionally equivalent to the first function. In one example, the system identifies a nested subquery in the nested data element and selects a transformation technique for transforming the nested subquery into a sequence of datasets that refer to one another. Additionally, or alternatively, the system may identify a correlated scalar subquery in the nested data element and may select a transformation technique for transforming the correlated scalar subquery into a scalar query and a correlated table joined with the scalar query. Additionally, or alternatively, the system may identify a correlated subquery in the nested data element and may select a transformation technique for transforming the correlated subquery into a set of separate datasets that are joined with one another using a filter condition.

In one example, the system selects at least one conversion technique for converting the first non-nested data element expressed in the first programming language to the second non-nested data element representing the second non-nested expression. The system may select the at least one conversion technique based at least in part on the first programming language. The system generates a second non-code representation that includes the second non-nested expression, for example, by modifying the first non-code representation at least by executing the at least one conversion technique. The at least one conversion technique and the at least one transformation technique may represent separate operations or a combined set of operations executed by the system.

In one example, the system determines that a first statement of the first non-nested data element is unsupported in the second programming language. The system replaces the first statement with a second statement that is supported in the second programming language. After replacing the first statement with the second statement, the system converts the first non-nested data element, including the second statement, to the second non-nested data element.

In one example, the system utilizes a JOIN expression or a semi-JOIN expression to transform a nested expression into a non-nested expression. For example, the following SQL statement represents a transformation of SQL statement (1) above into a functionally equivalent statement that utilizes non-nested expressions:

| | |
|---|---|
| (3) | SELECT E.* |
| | FROM Employees E |
| | JOIN ( |
| | SELECT MAX(Salary) AS MaxSalary FROM Employees |
| | ) AS MaxS ON E.Salary = MaxS.MaxSalary. |

In expression (3), MAX (Salary) is computed in a derived table (MaxS). The derived table (MaxS) is then joined with the Employees table.

In addition to transforming the one or more nested expressions into one or more functionally equivalent non-nested expressions, the system transforms the one or more non-nested expressions from the first programming language to a second programming language (Operation 210). The system may modify a first non-code representation based on one or more attributes of a second programming language to generate a second non-code representation suitable for representing code modules in the second programming language. Additionally, or alternatively, the system may generate the second non-code representation based on one or more attributes of the first programming language. The one or more attributes that the modification of the first non-code representation can be based on may include one or more attributes pertaining to whether or not the first programming language and/or the second programming language permits nested expressions. Additionally, or alternatively, the one or more attributes that the modification of the first non-code representation may include one or more attributes pertaining to whether or not the first programming language and/or the second programming language permits reuse of operand names for different operands.

Additionally, or alternatively, the one or more attributes that the modification of the first non-code representation can be based on may include one or more of the following: syntax, type system, data representation, object-oriented parameters, function models, control flow constructs, module packaging methodology, availability of standards libraries, execution model type, or language paradigm. Attributes pertaining to syntax may include reserved keywords, statement terminators, or block delimiters. Attributes pertaining to type system may include whether types are explicitly declared or inferred, whether typing is strong or weak, or whether the system distinguishes between primitive and object types. Attributes pertaining to data representation may include whether semantics are value-based or reference-based, whether the language provides pointers or references, or whether memory is managed through garbage collection or manual allocation. Attributes pertaining to the object-oriented model may include class definitions, inheritance rules, method overloading and overriding, or encapsulation. Attributes pertaining to the function model may include parameter passing rules, support for higher-order functions or lambdas, and handling of default or optional parameters. Attributes pertaining to control flow constructs may include looping mechanisms, exception handling, or pattern matching. Attributes pertaining to the module and packaging system may include how code is organized into files, modules, or namespaces. Attributes pertaining to the availability of standard libraries may include built-in data structures, string manipulation functions, or I/O operations. Attributes pertaining to the execution model may include whether the language is compiled or interpreted, requirements for bytecode or a virtual machine, or platform dependencies. Attributes pertaining to the language paradigm may include whether the language supports procedural, object-oriented, functional, or declarative styles.

In one example, the system utilizes an expression mapping table to transform an expression from the first programming language into the second programming language. For example, the code module may include the expression SUM (numbers). In the first programming language, the expression SUM (numbers) is utilized to compute the sum of a set of numbers. The second programming language may utilize the expression TOTAL (numbers) to compute the sum of the set of numbers. The system may determine, for example, based on the expression mapping table, that the expression TOTAL (numbers) in the second programming language is the functional equivalent of the expression SUM (numbers) in the first programming language. The system transforms the expression from the first programming language into the second programming language.

In one example, when the system transforms expressions from the first programming language to the second programming language, the system may transform expressions from the first programming language to an intermediate language or representation, and then from the intermediate language or representation to the second programming language. The transformation to the intermediate language or representation may reduce complexity of the transformation. The transformation to the intermediate language or representation may include transforming from a nested expression to a flattened expression, for example in the first programming language or in the intermediate programming language. The transformation from the intermediated language or representation to the second programming language may include transforming the flattened expression to the second programming language. Additionally, or alternatively, the transformation to the intermediate language or representation may include identifying operations that do not exist in the second programming language and replacing those operations in the first programming language with replacement operations that do exist in the second programming language. The transformation from the intermediated language or representation to the second programming language may include transforming the replacement operations from the first programming language to the second programming language. For example, semi-JOIN expressions are not supported by LoCode but can be emulated by a JOIN expression and a filter.

In one example, the system applies a naming convention to one or more operands of the first code module to ensure that the one or more operands have unique and/or consistent names (Operation 212). In one example, the first programming language permits reusing a same operand name for different operands, and one or more code modules include different operands that have the same name. The system may determine that the second programming language does not permit reusing the same operand name for different operands. In response to determining that the second programming language does not permit reusing the same operand name for different operands, the system converts one or more operand names to modified operand names at least by applying unique identifiers to the one or more operand names. In one example, the system converts the one or more operand names into modified operand names responsive to determining that a de-nesting operation will result in at least one nested expression that has the same operand name for different operands.

The naming convention may include assigning new names to the operands in the code module according to a naming convention that ensures that the operands have unique names. In one example, the naming convention may include appending a unique alpha-numeric prefix or suffix to the operands. Additionally, or alternatively, the naming convention may include identifying operands that do not have unique names and renaming the operands that are identified as having non-unique names. In one example, the naming convention ensures that the names of the operands are globally consistent throughout a set of code modules such as a set of code modules of a database application. Additionally, or alternatively, the naming convention may include utilizing an ML model, such as a large language model, to generate meaningful names for various expressions. The ML model may generate names for flattened expressions that are generated from nested expression. The names for the flattened expressions may reflect a totality of the nested expression. In one example, when a flattened expression is generated from a nested expression, the ML model may generate a name for the flattened expression that includes aliases and code from the nested expression.

In one example, the system identifies a first operand of the first code module that has a first name and converts the first name to a first modified name at least by applying a unique identifier to the first name. The first name of the first operand may match a second name of a second operand. The first modified name is different from the second name. In one example, the system also converts the second name to a second modified name that is different from the first modified name. In one example, the first operand is located at a first layer of the nested data element, and the second operand is located at a second layer of the nested data element. The first programming language may support reusing names in different layers. The second programming language may have a flat namespace that requires unique names. The first and/or second modified names may be utilized in the second non-nested expression expressed in the second programming language, for example, in accordance with the flat namespace that requires unique names.

In one example, the system identifies multiple instances of an operand that have different names. The system may identify a first instance of an operand of the first code module that has a first name and a second instance of the operand, for example, in a different code module or in a different layer of the first code module that has a second name different from the first name. The system applies a naming convention to ensure that the multiple instances of the operand have the same name. For example, the system may convert the second name to the first name.

After applying the naming convention to the one or more operations, the system generates a second code module expressed in the second programming language that is functionally equivalent to the first code module (Operation 214). In one example, the second code module that is output by the system represents a set of changes that the system applies to the first code module and/or to the first non-code representation. Additionally, or alternatively, the system may generate the second code module based on the transformed expressions and/or transformed data elements generated by the system. Upon generating the second code module, the system may provide the second code module as an output of the system.

B. Transforming Database Applications from a First Programming Language to a Second Programming Language

As described with reference to FIG. 2B, the system transforms a first database application into a second database application. The first database application includes a first set of database interaction code modules built in a first programming language. The first set of database interaction code modules may include nested expressions and non-nested expressions. The system utilizes a first set of one or more transformation techniques to transform nested expressions built in the first programming language into non-nested expressions built in a second programming language. Additionally, or alternatively, the system utilizes a second set of one or more transformation techniques to transform non-nested expressions from the first programming language into the second programming language. The non-nested expressions in the second set of database interaction code modules are functionally equivalent to the nested expressions in the first set of database interaction code modules. In one example, the second set of database interaction code modules are free of nested expressions. In one example, in addition to the first set of database interaction code modules, the first database application includes a set of general-purpose code modules. The system may generate a second database application at least by combining the general-purpose code modules with the second set of database interaction code modules that the system transformed from the first programming language into the second programming language. In one example, the first programming language is SQL. In one example, the second programming language is LoCode. It is

As shown in FIG. 2B, the system accesses a first database application (Operation 220). The first database application includes a first set of database interaction code modules built in a first programming language. The system may access the first database application from a data repository. In one example, the system receives a request to transform the first database application. The request may identify a location of the first database application to be transformed. The request may be provided to the system in response to an input, such as from a user device interface and/or from another computing application.

The system generates a syntax tree that represents a set of expressions of the first set of database interaction code modules (Operation 222). The system generates the syntax tree by parsing the first database application according to a grammar structure of the first programming language and translating at least a portion of the first database application into a tree-like structure. In one example, the system parses the first database application to identify the first set of database interaction code modules, and then the system parses the first set of database interaction code modules to identify the set of expressions of the first set of database interaction code modules. The system may generate a syntax tree that represents the first set of database interaction code modules. Additionally, or alternatively, the system may generate separate syntax trees for different sets of one or more database interaction code modules. In one example, the syntax tree is an abstract syntax tree. An abstract syntax tree focuses on logical structure and semantic meaning, leaving out unnecessary syntactic details, such as parentheses or punctuation.

The syntax tree may include a set of subtrees that correspond to the first set of database interaction code modules. A particular subtree may represent a particular database interaction code module. Additionally, or alternatively, the syntax tree may include a set of subtrees that correspond to the set of expressions of the first set of database interaction code modules. A particular subtree may represent a particular expression of a particular database interaction code module. In one example, a subtree that represents a database interaction code module includes one or more sub-subtrees that represent one or more expressions of the database interaction code module. In one example, nodes of the syntax tree represent expressions, clauses, operators, or operands. In one example, expressions are represented by internal nodes, and operands are represented by leaf nodes. In one example, nested expressions are represented by nested subtrees.

After generating the syntax tree, the system selects a candidate expression from the set of expressions represented by the syntax tree (Operation 224). The system may utilize a depth-first process to select a candidate expression from the syntax tree. In one example, the system starts from a leaf node of the syntax tree and traverses the syntax tree to identify an expression. Upon identifying a candidate expression, the system determines whether or not the candidate expression is a nested expression (Operation 226). In one example, the system determines whether the candidate expression is a nested expression or a non-nested expression. When the system determines that the candidate expression is a nested expression, the system utilizes a first set of one or more transformation techniques to transform the nested expression into a set of one or more non-nested expressions in a second programming language (Operation 228). Additionally, or alternatively, when the system determines that the candidate expression is a non-nested expression, the system utilizes a second set of one or more transformation techniques to transform the expression from the first programming language into a non-nested expression in the second programming language (Operation 230).

The first set of one or more transformation techniques that the system utilizes to transform a nested-expression into a non-nested expression may include one or more of the following: a JOIN expression, a semi-JOIN expression, a UNION expression, a WITH expression, a CASE expression, a GROUP BY expression, or a DISTINCT expression. A JOIN expression combines rows from two or more tables based on a related column. A semi-JOIN expression returns rows from a first table where a related row exists in a second table but without returning columns from the second table. A UNION expression combines the results of sets of two or more SELECT queries into a single result. A WITH expression defines a temporary result set that can be referenced within a subsequent query, such as a SELECT, INSERT, UPDATE, or DELETE query. A CASE expression provides conditional logic in SQL queries, allowing different outputs based on specified conditions. A GROUP BY expression aggregates rows that share the same values in specified columns into summary rows. A DISTINCT expression eliminates duplicate rows from a result set. In one example, the first set of one or more transformation techniques transforms a statement that includes a JOIN or semi-JOIN within a nested subexpression into a set of non-nested expressions. The set of non-nested expression may include a first subset of non-nested expression corresponding to the nested subexpression and a second subset of one or more non-nested expression that joins a result of the first subset of non-nested expressions.

In one example, the first set of one or more transformation techniques includes an ML model that generates non-nested expression that are functionally equivalent to a nested expression provided as an input to the model. In one example, the ML model receives a code module that includes one or more nested expressions as an input and generates a functionally equivalent code module that utilizes non-nested expressions and that is free of nested expressions. Additionally, or alternatively, the ML model may receive a nested expression as an input and may generate a non-nested expression that is functionally equivalent to the nested expression. In one example, the ML model receives the code module and/or the nested expression as the input in a first programming provides and provides the output in the second programming language. Additionally, or alternatively, the ML model may provide the output in the first programming language, and the system may subsequently transform the output from the first programming language into the second programming language.

In one example, the second set of one or more transformation techniques includes an expression mapping table. The expression mapping table includes a set of expressions written in the first programming language that is mapped to one or more functionally equivalent expressions written in the second programming language.

In one example, the second set of one or more transformation techniques includes an ML model that transforms expressions from a first programming language into a second programming language. In one example, the ML model receives a code module built in a first programming language as an input and generates a functionally equivalent code module built in a second programming language. The code module received as the input may include one or more non-nested expressions. Additionally, or alternatively, the ML model may receive a non-nested expression built in the first programming language as an input and may generate a functionally equivalent expression built in the second programming language.

In one example, the system identifies one or more operands of the code modules and applies a naming convention to the one or more operands to ensure that the one or more operands have unique and/or consistent names, for example, as described above with reference to FIG. 2A.

After transforming the expression from the first programming language into the second programming language, the system determines whether the set of expressions represented by the syntax tree includes an additional expression (Operation 232). When the system determines that the set of expressions represented by the syntax tree includes an additional expression that has not yet been transformed into the second programming language, the system returns to Operation 224 and selects the additional expression. When the system determines that the set of expressions represent by the syntax tree does not include an additional expression that has yet to be transformed to the second programming language, the system assembles the set of non-nested expressions into a second set of database interaction code modules built in the second programming language (Operation 234). In one example, the system assembles the second set of database interaction code modules by generating a modified syntax tree as the expressions are transformed and then generates the second set of code modules based on the modified syntax tree. In one example, the system generates modified code modules that are built in the second programming language as the expressions are transformed from the first programming language into the second programming language.

After assembling the non-nested expressions into the second set of database interaction code modules, the system outputs a second database application that includes the second set of database interaction code modules (Operation 236). In one example, the system generates the second database application by combining the second set of database interaction code modules with a set of general-purpose code modules from the first database application. In one example, the general-purpose code modules are unmodified. In one example, the system modifies one or more general-purpose code modules to reference one or more of the second set of database interaction code modules in the second programming language. In one example, one or more code modules of the second set of database interaction code modules have a different name relative to the corresponding code modules of the first set of database interaction code modules. The system may modify one or more general-purpose code modules to reference a different name of one or more of the second set of database interaction code modules. Additionally, or alternatively, one or more operands of the second set of database interaction code modules have a different name relative to the corresponding operands of the first set of database interaction code modules. The system may modify one or more general-purpose code modules to reference a different name of one or more operands of the second set of database interaction code modules.

### 4. EXAMPLE EMBODIMENTS

Several detailed examples are described below for purposes of clarity. Components and/or operations described below should be understood as one specific example that may not be applicable to certain embodiments. Accordingly, components and/or operations described below should not be construed as limiting the scope of any of the claims. The system may transform code modules that include one or more of the example statements described herein. In one example, the code module may include a sequences of multiple statements and/or multiple layers of nested statements.

Some examples are related to primitives that can be combined using joins, set operation, nesting, other primitives or subqueries. An example with a table reference may substituted by a subquery, a join of a table and a subquery etc. A similar approach can be used for expressions with nested subexpressions.

The recursive structure of such nested structures can be processed by a SQL parser using recursive parser rules and transformed into an abstract syntax tree that represents the unrolled structure of the SQL statement.

In one example, the system verifies and/or operates under a presumption that datasets of subqueries and tables have proper aliases or otherwise the system may create dummy names. In one example, the system verifies and/or operates under a presumption that the global, flat namespace requires the introduction of unique names. This is implemented in the below examples as appended globally unique IDs (GUID). The GUID can be created using known methods such as hashing of combined tables names, e.g. using MD5. In one example, the system verifies and/or operates under a presumption that datasets typically will contain only columns needed for the operation. This reduces storage requirements and more importantly improves performance.

### A. Example Implementation Details

Select statements are very similar to LoCode. Just the syntax for assigning column is different. Common DB functions such as concatenation are transformed to equivalent LoCode functions.

LoCode does not support direct nesting. Instead, it defines separate datasets for each subquery that can be referenced by another LoCode dataset, e.g. the dataset defined by the outer query.

Not all common SQL can be transformed into equivalent LoCode statements because LoCode does not support all required features. However, in many cases the original SQL may be rewritten into an equivalent SQL statement.

In one example, the translator logic may include of two phases: (1) Identify SQL statements that are not supported by LoCode constructs, such as EXISTS, and rewrite such statements to use SQL that is supported; and (2) Transform the rewritten SQL to LoCode. The benefit of the approach is the separation of concerns that reduce the overall complexity of the transformation.

### B. Statement with Function

In one example, the system is provided the following SQL statement:

| | |
|---|---|
| (3) | // NAME: OUTPUT |
| | select FK1, |
| | FK2, |
| | ATTR1 ∥ ‘-’ ∥ ATTR2 as ATTR, |
| | case when ATTR1 = ‘0’ then ‘−1’ |
| | else trim(ATTR1) end FLG; |
| | from TABLE |
| | order by FK1 |

In the above example, a comment starting with “NAME:” will be transformed into the name of the output dataset. Otherwise, the name of the public dataset will be DEFAULT_DS. SQL's ORDER BY is not supported by LoCode outside of the context of windowing functions and can be ignored.

In one example, the system transforms SQL statement (3) into the following LoCode statement:

| | |
|---|---|
| (4) | IMPORT SOURCE TABLE |
| | DEFINE PUBLIC DATASET OUTPUT |
| | ROWSOURCE TABLE; |
| | THIS[FK1] = TABLE.FK1; |
| | THIS[FK2] = TABLE.FK2; |
| | THIS[ATTR] = CONCAT_WS(‘-’,TABLE.ATTR1, TABLE |
| | ATTR2); |
| | THIS[FLG] = CASE WHEN TABLE.ATTR1 = ‘0’ THEN ‘−1’ |
| | ELSE TRIM(TABLE.ATTR1) END; |
| | END |

### C. Statement with Filter

In one example, the system is provided the following SQL statement:

| | |
|---|---|
| (5) | // NAME: OUTPUT |
| | select FK1, |
| | FK2, |
| | ATTR |
| | from TABLE |
| | where ATTR in (‘A’, ‘B’, ‘C’) |
| | AND not FK2 is null |

In one example, filters are transformed almost 1-1 to LoCode expressions.

In one example, the system transforms SQL statement (5) into the following LoCode statement:

| | |
|---|---|
| (6) | IMPORT SOURCE TABLE |
| | DEFINE PUBLIC DATASET OUTPUT |
| | ROWSOURCE TABLE |
| | WHERE TABLE.ATTR IN (‘A’, ‘B’, ‘C’) |
| | AND NOT TABLE.FK2 IS NULL; |
| | THIS[FK1] = TABLE.FK1; |
| | THIS[FK2] = TABLE.FK2; |
| | THIS[ATTR] = TABLE.ATTR; |
| | END |

### D. Statement with Function

In one example, the system is provided the following SQL statement:

| | |
|---|---|
| (7) | // NAME: OUTPUT |
| | select FK1, |
| | FK2, |
| | ATTR1 ∥ ‘-’ ∥ ATTR2 as ATTR, |
| | case when ATTR1 = ‘0’ then ‘−1’ |
| | else trim(ATTR1) end FLG; |
| | from TABLE |
| | order by FK1 |

In one example, a comment starting with “NAME:” will be transformed into the name of the output dataset. Otherwise, the name of the public dataset will be DEFAULT_DS.

In one example, select statements are very similar to LoCode. Just the syntax for assigning column is different. Common functions such as concatenation are transformed to equivalent LoCode functions after the AST is analyzed. SQL's ORDER BY is not supported by LoCode outside of the context of windowing functions and can be ignored.

In one example, the system transforms SQL statement (7) into the following LoCode statement:

| | |
|---|---|
| (8) | IMPORT SOURCE TABLE |
| | DEFINE PUBLIC DATASET OUTPUT |
| | ROWSOURCE TABLE; |
| | THIS[FK1] = TABLE.FK1; |
| | THIS[FK2] = TABLE.FK2; |
| | THIS[ATTR] = CONCAT_WS(‘-’,TABLE.ATTR1, TABLE |
| | ATTR2); |
| | THIS[FLG] = CASE WHEN TABLE.ATTR1 = ‘0’ THEN ‘−1’ |
| | ELSE TRIM(TABLE.ATTR1) END; |
| | END |

### E. Statement with GROUP BY Expression

In one example, the system is provided the following SQL statement:

| | |
|---|---|
| (9) | // NAME: OUTPUT |
| | select ID, |
| | ATTR1, |
| | ATTR2, |
| | ATTR3 |
| | from TABLE |
| | group by ID, ATTR1, ATTR2, ATTR3 |

In one example, group by is used together with aggregation functions but can also be used separately.

In one example, the system transforms SQL statement (9) into the following LoCode statement:

| | |
|---|---|
| (10) | IMPORT SOURCE TABLE |
| | DEFINE PUBLIC DATASET OUTPUT |
| | ROWSOURCE TABLE; |
| | THIS[ID] = TABLE.ID; |
| | THIS[ATTR1] = TABLE.ATTR1; |
| | THIS[ATTR2] = TABLE.ATTR2; |
| | THIS[ATTR3] = TABLE.ATTR3 |
| | GROUPBY [ID, ATTR1, ATTR2, ATTR3]; |
| | END |

### F. Statement with Aggregate Function

In one example, the system is provided the following SQL statement:

| | |
|---|---|
| (11) | // NAME: OUTPUT |
| | select FK1 AS FK |
| | FK2, |
| | sum(ATTR) as MEASURE |
| | from TABLE |
| | group by FK1, FK2 |

In one example, SQL aggregation functions such as SUM, MIN, MAX, AVG are transformed almost 1-1 to LoCode expressions.

In one example, the alias column name is transformed into the target name of the LoCode dataset.

In one example, the system transforms SQL statement (11) into the following LoCode statement:

| | |
|---|---|
| (12) | IMPORT SOURCE TABLE |
| | DEFINE PUBLIC DATASET OUTPUT ROWSOURCE TABLE; |
| | THIS[FK] = TABLE.FK1; |
| | THIS[FK2] = TABLE.FK2; |
| | THIS[MEASURE] = SUM(TABLE.ATTR); |
| | GROUPBY[FK,FK2]; |
| | END |

### G. Statement with Windowing Function

In one example, the system is provided the following SQL statement:

| | |
|---|---|
| (13) | // NAME: OUTPUT |
| | select FK, |
| | ATTR, |
| | row_number( ) over(partition by FK order by ATTR) RN |
| | from TABLE |

In one example, SQL windowing functions such as LEAD, LAG, etc have matching to LoCode expressions with similar syntax. Only a subset of SQL windowing functions exist in LoCode.

In one example, the system transforms SQL statement (13) into the following LoCode statement:

| | |
|---|---|
| (14) | IMPORT SOURCE TABLE |
| | DEFINE PUBLIC DATASET OUTPUT |
| | ROWSOURCE TABLE; |
| | THIS[FK] = TABLE.FK; |
| | THIS[FK2] = TABLE.FK2; |
| | THIS[RN] = ROW_NUMBER( ) OVER(PARTITION BY |
| | TABLE.FK |
| | ORDER BY TABLE.ATTR); |
| | END |

### H. Statement with DISTINCT Expression

In one example, the system is provided the following SQL statement:

| | |
|---|---|
| (15) | // NAME: OUTPUT |
| | select DISTINCT ID, |
| | ATTR1, |
| | ATTR2, |
| | ATTR3 |
| | from TABLE |

In one example, distinct is currently not a feature that is supported in LoCode and therefore the system utilizes a rewrite operation to transform SQL statement (15) into the following transformable SQL statement:

| | |
|---|---|
| (16) | // NAME: OUTPUT |
| | select ID, |
| | ATTR1, |
| | ATTR2, |
| | ATTR3 |
| | from TABLE |
| | group by ID, ATTR1, ATTR2, ATTR3 |

In one example, the system transforms SQL statement (16) into the following LoCode statement:

| | |
|---|---|
| (17) | IMPORT SOURCE TABLE |
| | DEFINE PUBLIC DATASET OUTPUT |
| | ROWSOURCE TABLE; |
| | THIS[ID] = TABLE.ID; |
| | THIS[ATTR1] = TABLE.ATTR1; |
| | THIS[ATTR2] = TABLE.ATTR2; |
| | THIS[ATTR3] = TABLE.ATTR3 |
| | GROUPBY [ID, ATTR1, ATTR2, ATTR3]; |
| | END |

### I. Statement with JOIN Expression

In one example, the system is provided the following SQL statement:

| | |
|---|---|
| (18) | // NAME: JOINED_DS |
| | select T1.ID |
| | T1.ATTR1, |
| | T2.ATTR1 as ATTR2 |
| | from TABLE1 T1 |
| | inner join TABLE2 as T2 |
| | on T1.ID = TABLE2.T1_FK |
| | and not T1.ID = ‘−1’ |

In one example, one more than one source table is involved in a SQL statement, table aliases become important that are mapped to aliases in LoCode. In one example, the aliases are made globally unique as well.

In one example, subsequent datasets may refer to the dataset name or the alias. In one example, alias is utilized if the same dataset is used several times such as in a self-join or a dataset is joined multiple times with another dataset.

In one example, the system transforms SQL statement (18) into the following LoCode statement:

| | |
|---|---|
| (19) | IMPORT SOURCE TABLE1 |
| | DEFINE PRIVATE DATASET TABLE1_GUID1 |
| | ROWSOURCE TABLE1; |
| | THIS = TABLE1; // may also only define required column subset |
| | END |
| | ALIAS LOCAL TABLE1_GUID1 AS T1_GUID1 |
| | IMPORT SOURCE TABLE2 |
| | DEFINE PRIVATE DATASET TABLE2_GUID2 |
| | ROWSOURCE TABLE2; |
| | THIS = TABLE2; // may also only define required column subset |
| | END |
| | ALIAS LOCAL TABLE 2_GUID2 AS T2_GUID2 |
| | DEFINE PUBLIC DATASET JOINED_DS |
| | ROWSOURCE T1_GUID1 |
| | INNER JOIN T2_GUID2 ON (T1_GUID1.ID = |
| | T2_GUID2.T1_FK AND |
| | NOT T1_GUID1.ID = ‘−1’); |
| | THIS[T1_ID] = T1_GUID1. T1_ID; |
| | THIS[ATTR1] = T1 _GUID1.ATTR1 |
| | THIS[ATTR2] = T2 _GUID2.ATTR1 |
| | REFRESH ON CHANGES IN [T1_GUID1, T2_GUID2]; |
| | END |

### J. Statement with Set Operations

In one example, the system is provided the following SQL statement:

| | |
|---|---|
| (20) | // NAME: UNION_DS |
| | select * |
| | from (select * from TABLE1) |
| | union |
| | (select * from TABLE2) |

In one example, supported SQL set operations in LoCode include union, union_all, intersect, and minus. In one example, private datasets and aliases have a unique name, e.g. by adding a globally unique ID, to avoid collisions in a flat LoCode namespace.

In one example, the system transforms SQL statement (20) into the following LoCode statement:

| | |
|---|---|
| (21) | IMPORT SOURCE TABLE1 |
| | DEFINE PRIVATE DATASET TABLE1_GUID1 |
| | ROWSOURCE TABLE1; |
| | THIS = TABLE1; |
| | END |
| | ALIAS LOCAL TABLE1_GUID1 AS T1_GUID1 |
| | IMPORT SOURCE TABLE2 |
| | DEFINE PRIVATE DATASET TABLE2_GUID2 |
| | ROWSOURCE TABLE2; |
| | THIS = TABLE2; |
| | END |
| | ALIAS LOCAL TABLE 2_GUID2 AS T2_GUID2 |
| | DEFINE PUBLIC DATASET UNION_DS |
| | ROWSOURCE UNION[T1_GUID1, T2_GUID2]; |
| | THIS = T1_GUID1; |
| | REFRESH ON CHANGES IN [T1_GUID1, T2_GUID2]; |
| | END |

### K. Statement with Nested Subquery

In one example, the system is provided the following SQL statement:

| | |
|---|---|
| (22) | // NAME : NESTED_DS |
| | select R.ID, |
| | R.ATTR |
| | from (select ID, |
| | ATTR, |
| | row_number( ) over(partition by ID |
| | order by ATTR) RN |
| | from TABLE1) R |
| | where R.RN = 1 |

In one example, nesting is replaced by a sequence of datasets that refer to each other.

In one example, the system transforms SQL statement (22) into the following LoCode statement:

| | |
|---|---|
| (23) | IMPORT SOURCE TABLE1 |
| | DEFINE PRIVATE DATASET TABLE1_GUID1 |
| | ROWSOURCE TABLE1; |
| | THIS[FK] = TABLE1.ID; |
| | THIS[ATTR] = TABLE1.ATTR; |
| | THIS[RN] = ROW_NUMBER( ) OVER(PARTITION BY |
| | TABLE1.ID |
| | ORDER BY TABLE1.ATTR); |
| | END |
| | ALIAS LOCAL TABLE1_GUID1 AS T1_GUID1 |

DEFINE PUBLIC DATASET NESTED_DS
ROWSOURCE T1_GUID1

```
WHERE T1_GUID1.RN = 1;
  THIS[ID] = T1_GUID1.ID;
  THIS[ATTR] = T1_GUID1.ATTR;
```

END

### L. Statement with Correlated Scalar Subquery

In one example, the system is provided the following SQL statement:

| | |
|---|---|
| (24) | // NAME: COMPLEX_DS |
| | select TABLE1.ID, |
| | (select count(*) from TABLE2 |
| | where TABLE1.ID=TABLE2.ID) CHD_CNT |
| | from TABLE1 |

In one example, for the correlated scalar subquery in LoCode a dataset is created that contains the exposed columns of the scalar query and the columns used for joining with the outer, correlated table.

In one example, while the LoCode below is correct, it can be further optimized by defining private datasets with only the columns used in the target dataset COMPLEX_DS.

In one example, the system transforms SQL statement (24) into the following LoCode statement:

| | |
|---|---|
| (25) | IMPORT SOURCE TABLE1 |
| | DEFINE PRIVATE DATASET TABLE1_GUID1 |
| | ROWSOURCE TABLE1; |
| | THIS = TABLE1; // may also only define required column |
| | subset |
| | END |
| | ALIAS LOCAL TABLE1_GUID1 AS T1_GUID1 |
| | IMPORT SOURCE TABLE2 |
| | DEFINE PRIVATE DATASET TABLE2_GUID2 |
| | ROWSOURCE TABLE2; |
| | THIS[ID] = TABLE2.ID; |
| | THIS[CHD_CNT] = COUNT(*) |
| | GROUPBY[TABLE2.ID] |
| | END |
| | ALIAS LOCAL TABLE 2_GUID2 AS T2_GUID2 |
| | DEFINE PUBLIC DATASET COMPLEX_DS |
| | ROWSOURCE T1_GUID1 |
| | INNER JOIN AS T2_GUID2 ON (T1_GUID1.ID = |
| | T2_GUID2.ID) |
| | THIS[ID] = T1_GUID1.ID; |
| | THIS[CHD_CNT] = T2_GUID2.CHD_CNT; |
| | REFRESH ON CHANGES IN [T1_GUID1, T2_GUID2]; |
| | END |

### M. Statement with Correlated Subquery

In one example, the system is provided the following SQL statement:

| | |
|---|---|
| (26) | // NAME: CORRELATED_DS |
| | SELECT ID, |
| | NAME, |
| | SALARY |
| | FROM EMPLOYEES E |
| | WHERE SALARY > (SELECT AVG(SALARY) SALARY_AVG |
| | FROM EMPLOYEES |
| | WHERE DEP_ID = E.DEP_ID) |

In one example, correlated subqueries are transformed in a separate dataset that includes the selected columns and the correlated column. The correlated query is subsequently joined with the dataset for the outer table or dataset and combined with a filter condition.

In one example, the system transforms SQL statement (26) into the following LoCode statement:

| | |
|---|---|
| (27) | IMPORT SOURCE EMPLOYEES |
| | DEFINE PRIVATE DATASET EMPLOYEES_GUID0 |
| | ROWSOURCE EMPLOYEES; |
| | THIS[ID] = EMPLOYEES.ID; |
| | THIS[NAME] = EMPLOYEES.NAME; |
| | THIS[SALARY] = EMPLOYEES.SALARY; |
| | THIS[DEP_ID] = EMPLOYEES.DEP_ID |
| | END |
| | ALIAS LOCAL EMPLOYEES_GUID0 AS E_GUID1 |
| | ALIAS LOCAL EMPLOYEES_GUID0 AS E_GUID2 |
| | DEFINE PRIVATE DATASET SUBQUERY_GUID3 |
| | ROWSOURCE E_GUID2; |
| | THIS[DEP_ID] = E_GUID2.DEP_ID; |
| | THIS[SALARY_AVG] = AVG(E_GUID2.SALARY); |
| | GROUPBY [DEP_ID] |
| | END |
| | DEFINE PUBLIC DATASET CORRELATED_DS |
| | ROWSOURCE E_GUID1 |
| | INNER JOIN SUBQUERY_GUID1 |
| | ON (SUBQUERY_GUID3.DEP_ID = E_GUID1.DEP_ID) |
| | WHERE E_GUID1.SALARY > |
| | SUBQUERY_GUID3.SALARY_AVG |
| | THIS[ID] = E_GUID1.ID; |
| | THIS[NAME] = E_GUID1.NAME; |
| | THIS[SALARY] = E_GUID1.SALARY; |
| | REFRESH ON CHANGES IN [E1_GUID1, |
| | SUBQUERY_GUID3]; |
| | END |

### N. Statement with EXISTS Subquery

In one example, the system is provided the following SQL statement:

| | |
|---|---|
| (28) | // NAME: EXISTS_DS |
| | SELECT ID, |
| | ATTR |
| | FROM TABLE1 T1 |
| | WHERE EXISTS (SELECT 1 |
| | FROM TABLE2 T2 |
| | WHERE T1.ID = T2.ID AND T2.ATTR2 = ‘ABC’) |

In one example, semi joins EXISTS is unrolled in a similar manner as correlated subqueries. The implementation if the filter condition T2.ATTR2=‘ABC’ is possible in the dataset defined for TABLE2 (shown here), the join condition in the target dataset EXISTS_DS. The described one below in average will be smaller because the dataset produced for TABLE2 will be smaller.

In one example, because the EXISTS semi-join is not supported by LoCode, the system transforms the query into a statement that uses SQL that can be transformed into LoCode.

In one example, the system transforms SQL statement (28) into the following SQL statement:

| | |
|---|---|
| (29) | // NAME: EXISTS_DS |
| | select T1.ID, |
| | T1.ATTR |
| | from TABLE1 T1 |
| | inner join TABLE2 T2 on (T1.ID = T2.ID and T2.ATTR2 = |
| | ‘ABC’) |

In one example, the system transforms SQL statement (29) into the following LoCode statement:

| | |
|---|---|
| (30) | IMPORT SOURCE TABLE1 |
| | DEFINE PRIVATE DATASET TABLE1_GUID1 |
| | ROWSOURCE TABLE1; |
| | THIS[ID] = TABLE1.ID; |
| | THIS[ATTR] = TABLE1.ATTR; |
| | END |
| | ALIAS LOCAL TABLE1_GUID1 AS T1_GUID1 |
| | IMPORT SOURCE TABLE2 |
| | DEFINE PRIVATE DATASET TABLE2_GUID2 |
| | ROWSOURCE TABLE2 |
| | WHERE TABLE2.ATTR2 = ‘ABC’; |
| | THIS[ID] = TABLE2.ID; |
| | END |
| | ALIAS LOCAL TABLE2_GUID2 AS T2_GUID2 |
| | DEFINE PUBLIC DATASET EXISTS_DS |
| | ROWSOURCE T1_GUID1 |
| | INNER JOIN T2_GUID2 |
| | ON (T1_GUID1.ID = T2_GUID2.ID) |
| | THIS[ID] = T1_GUID1.ID; |
| | THIS[ATTR] = T1_GUID1.ATTR; |
| | REFRESH ON CHANGES IN [T1_GUID1, T2_GUID2]; |
| | END |

### O. Statement with NOT EXISTS Subquery

In one example, the system is provided the following SQL statement:

| | |
|---|---|
| (31) | // NAME: NOT_EXISTS_DS |
| | SELECT ID, |
| | ATTR |
| | FROM TABLE1 T1 |
| | WHERE NOT EXISTS (SELECT 1 |
| | FROM TABLE2 T2 |
| | WHERE T1.ID = T2.ID AND T2.ATTR2 = ‘ABC’) |

In one example, LoCode does not support NOT EXISTS. In one example, the system transforms SQL statement (31) into the following SQL statement to use features supported by LoCode:

| | |
|---|---|
| (32) | // NAME: NOT_EXISTS_DS |
| | select T1.ID, |
| | T1.ATTR |
| | from TABLE1 T1 |
| | left outer join TABLE2 T2 on (T1.ID = T2.ID and |
| | T2.ATTR2 = ‘ABC’) |
| | where T2.ID is null |

In one example, the code above is only correct if the TABLE2 dataset defined by the join condition includes no duplicates per ID. Otherwise, the resulting dataset will have duplicates. To avoid this a ‘distinct’ keywork needs to be added.

In one example, the system transforms SQL statement (32) into the following LoCode statement:

| | |
|---|---|
| (33) | IMPORT SOURCE TABLE1 |
| | DEFINE PRIVATE DATASET TABLE1_GUID1 |
| | ROWSOURCE TABLE1; |
| | THIS[ID] = TABLE1.ID; |
| | THIS[ATTR] = TABLE1.ATTR; |
| | END |
| | ALIAS LOCAL TABLE1_GUID1 AS T1_GUID1 |
| | IMPORT SOURCE TABLE2 |
| | DEFINE PRIVATE DATASET TABLE2_GUID2 |
| | ROWSOURCE TABLE2; |
| | THIS[ID] = TABLE2.ID; |
| | THIS[ATTR2] = TABLE2.ATTR2; |
| | END |
| | ALIAS LOCAL TABLE2_GUID2 AS T2_GUID2 |
| | DEFINE PUBLIC DATASET NOT_EXISTS_DS |
| | ROWSOURCE T1_GUID1 |
| | LEFT OUTER JOIN T2_GUID2 |
| | ON (T1_GUID1.ID = T2_GUID2.ID AND |
| | T2_GUID2.ATTR2 = ‘ABC’) |
| | WHERE T2_GUID2.ID IS NULL |
| | THIS[ID] = TABLE1_GUID1.ID; |
| | THIS[ATTR] = TABLE1_GUID1.ATTR; |
| | REFRESH ON CHANGES IN [T1_GUID1, T2_GUID2]; |
| | END |

### 5. EXAMPLE MACHINE LEARNING SYSTEM

### A. Example Architecture of a Machine Learning System

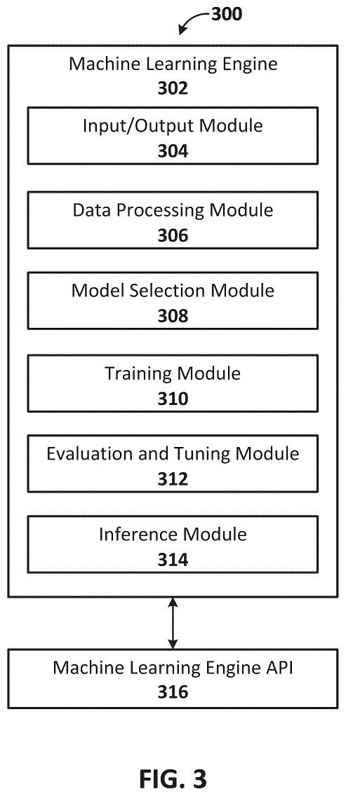

FIG. 3 illustrates an example architecture of an ML system 300. The ML system 300 includes an ML engine 302 in accordance with one or more embodiments. As illustrated in FIG. 3, ML engine 302 includes input/output module 304, data preprocessing module 306, model selection module 308, training module 310, evaluation and tuning module 312, and inference module 314.

In accordance with an embodiment, input/output module 304 serves as the primary interface for data entering and exiting the system, managing the flow and integrity of data. This module may accommodate a wide range of data sources and formats to facilitate integration and communication within the ML architecture.

In an embodiment, an input handler within input/output module 304 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 304 to be versatile in different operational contexts, whether processing historical datasets or streaming data.

In accordance with an embodiment, input/output module 304 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the ML process.

In an embodiment, an output handler within input/output module 304 includes an output framework designed to handle the distribution and exportation of outputs, predictions, or insights. Using the output framework, input/output module 304 formats these outputs into user-friendly and accessible formats, such as reports, visualizations, or data files compatible with other systems. Input/output module 304 also ensures secure and efficient transmission of these outputs to end-users or other systems in an embodiment and may employ encryption and secure data transfer protocols to maintain data confidentiality.

In accordance with an embodiment, data preprocessing module 306 transforms data into a format suitable for use by other modules in ML engine 302. For example, data preprocessing module 306 may transform raw data into a normalized or standardized format suitable for training ML models and for processing new data inputs for inference. In an embodiment, data preprocessing module 306 acts as a bridge between the raw data sources and the analytical capabilities of ML engine 302.

In an embodiment, data preprocessing module 306 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 306 may be configured to handle anomalies in different ways depending on context. Data preprocessing module 306 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 306 includes a feature encoding framework that ensures categorical variables are transformed into a format that can be easily interpreted by ML algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 306 processes new data for inference, data preprocessing module 306 replicates the same preprocessing steps to ensure consistency with the training data format. This helps to avoid discrepancies between the training data format and the inference data format, thereby reducing the likelihood of inaccurate or invalid model predictions.

In an embodiment, model selection module 308 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 308 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 308 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 308 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 308 also considers computational efficiency and resource constraints. This is meant to help ensure the selected model is both accurate and practical in terms of computational and time requirements. In an embodiment, certain features of model selection module 308 are configurable such as a configured bias toward (or against) computational efficiency.

In accordance with an embodiment, training module 310 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 310 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 310 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 310 includes logic to handle different types of data and learning tasks. For instance, it includes different training routines for supervised learning (where the training data comes with labels) and unsupervised learning (without labeled data). In the case of deep learning models, training module 310 also manages the complexities of training neural networks that include initializing network weights, choosing activation functions, and setting up neural network layers.

In an embodiment, evaluation and tuning module 312 incorporates dynamic feedback mechanisms and facilitates continuous model evolution to help ensure the system's relevance and accuracy as the data landscape changes. Evaluation and tuning module 312 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 312 performs continuous model tuning by using hyperparameter optimization. Evaluation and tuning module 312 performs an exploration of the hyperparameter space using algorithms, such as grid search, random search, or more sophisticated methods like Bayesian optimization. Evaluation and tuning module 312 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 312 integrates data feedback and updates the model. Evaluation and tuning module 312 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 312 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 312 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 314 transforms data raw data into actionable, precise, and contextually relevant predictions. In addition to processing and applying a trained model to new data, inference module 314 may also include post-processing logic that refines the raw outputs of the model into meaningful insights.

In an embodiment, inference module 314 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 314 transforms the outputs of a trained model into definitive classifications. Inference module 314 employs the underlying model as a tool to generate probabilistic outputs for each potential class. It then engages in an interpretative process to convert these probabilities into concrete class labels.

In an embodiment, when inference module 314 receives the probabilistic outputs from the model, it analyzes these probabilities to determine how they are distributed across some or every potential class. If the highest probability is not significantly greater than the others, inference module 314 may determine that there is ambiguity or interpret this as a lack of confidence displayed by the model.

In an embodiment, inference module 314 uses thresholding techniques for applications where making a definitive decision based on the highest probability might not suffice due to the critical nature of the decision. In such cases, inference module 314 assesses if the highest probability surpasses a certain confidence threshold that is predetermined based on the specific requirements of the application. If the probabilities do not meet this threshold, inference module 314 may flag the result as uncertain or defer the decision to a human expert. Inference module 314 dynamically adjusts the decision thresholds based on the sensitivity and specificity requirements of the application, subject to calibration for balancing the trade-offs between false positives and false negatives.

In accordance with an embodiment, inference module 314 contextualizes the probability distribution against the backdrop of the specific application. This involves a comparative analysis, especially in instances where multiple classes have similar probability scores, to deduce the most plausible classification. In an embodiment, inference module 314 may incorporate additional decision-making rules or contextual information to guide this analysis, ensuring that the classification aligns with the practical and contextual nuances of the application.

In regression models, where the outputs are continuous values, inference module 314 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 314 incorporates domain-specific adjustments into its post-processing routine. This involves tailoring the model's output to align with specific industry knowledge or contextual information. For example, in financial forecasting, inference module 314 may adjust predictions based on current market trends, economic indicators, or recent significant events, ensuring that the outputs are both statistically accurate and practically relevant.

In an embodiment, inference module 314 includes logic to handle uncertainty and ambiguity in the model's predictions. In cases where inference module 314 outputs a measure of uncertainty, such as in Bayesian inference models, inference module 314 interprets these uncertainty measures by converting probabilistic distributions or confidence intervals into a format that can be easily understood and acted upon. This provides users with both a prediction and an insight into the confidence level of that prediction. In an embodiment, inference module 314 includes mechanisms for involving human oversight or integrating the instance into a feedback loop for subsequent analysis and model refinement.

In an embodiment, inference module 314 formats the final predictions for end-user consumption. Predictions are converted into visualizations, user-friendly reports, or interactive interfaces. In some systems, like recommendation engines, inference module 314 also integrates feedback mechanisms, where user responses to the predictions are used to continually refine and improve the model, creating a dynamic, self-improving system.

### B. Example Operations of a Machine Learning System

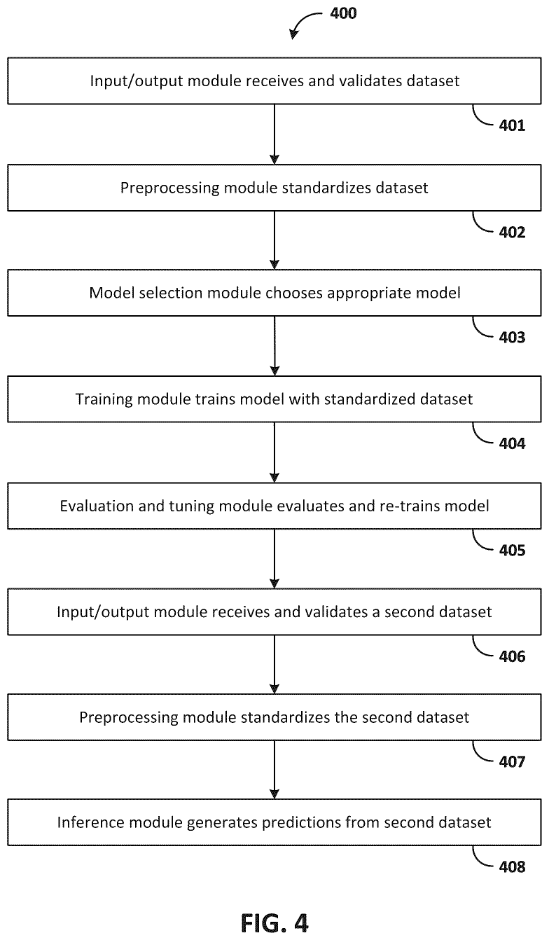

FIG. 4 illustrates example operations 400 of an ML system in one or more embodiments. In an embodiment, input/output module 304 receives a dataset intended for training (Operation 401). This data can originate from diverse sources, like databases or real-time data streams, and in varied formats, such as CSV, JSON, or XML. Input/output module 304 assesses and validates the data, ensuring its integrity by checking for consistency, data ranges, and types.

In an embodiment, training data is passed to data preprocessing module 306. Here, the data undergoes a series of transformations to standardize and clean it, making it suitable for training ML models (Operation 402). This involves normalizing numerical data, encoding categorical variables, and handling missing values through techniques like imputation.

In an embodiment, prepared data from the data preprocessing module 306 is then fed into model selection module 308 (Operation 403). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 310 trains the selected model with the prepared dataset (Operation 404). It implements learning algorithms to adjust the model's internal parameters, optimizing them to identify patterns and relationships in the training data. Training module 310 also addresses the challenge of overfitting by implementing techniques, like regularization and early stopping, ensuring the model's generalizability.

In an embodiment, evaluation and tuning module 312 evaluates the trained model's performance using the validation dataset (Operation 405). Evaluation and tuning module 312 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 304 receives a dataset intended for inference. Input/output module 304 assesses and validates the data (Operation 406).

In an embodiment, data preprocessing module 306 receives the validated dataset intended for inference (Operation 407). Data preprocessing module 306 ensures that the data format used in training is replicated for the new inference data, maintaining consistency and accuracy for the model's predictions.

In an embodiment, inference module 314 processes the new data set intended for inference, using the trained and tuned model (Operation 408). It applies the model to this data, generating raw probabilistic outputs for predictions. Inference module 314 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, the ML system 300 includes an ML engine API 316. The ML engine API 316 allows for applications to leverage ML engine 302. In an embodiment, ML engine API 316 may be built on a RESTful architecture and offer stateless interactions over standard HTTP/HTTPS protocols. ML engine API 316 may feature a variety of endpoints, each tailored to a specific function within ML engine 302. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, ML engine API 316 is equipped to support SOAP-based interactions. This extension involves defining a WSDL (Web Services Description Language) document that outlines the API's operations and the structure of request and response messages. In an embodiment, ML engine API 316 supports various data formats and communication styles. In an embodiment, ML engine API 316 endpoints may handle requests in JSON format or any other suitable format. For example, ML engine API 316 may process XML, and it may also be engineered to handle more compact and efficient data formats, such as Protocol Buffers or Avro, for use in bandwidth-limited scenarios.

In an embodiment, ML engine API 316 is designed to integrate WebSocket technology for applications necessitating real-time data processing and immediate feedback. This integration enables a continuous, bi-directional communication channel for a dynamic and interactive data exchange between the application and ML engine 302.

### C. Example Generative Models of a Machine Learning System

A generative model is an ML model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 304, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 306 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 308, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 310, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs or TPUs to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 312 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 314, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced ML model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in ML by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 6. EXAMPLE COMPUTER NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an API.

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

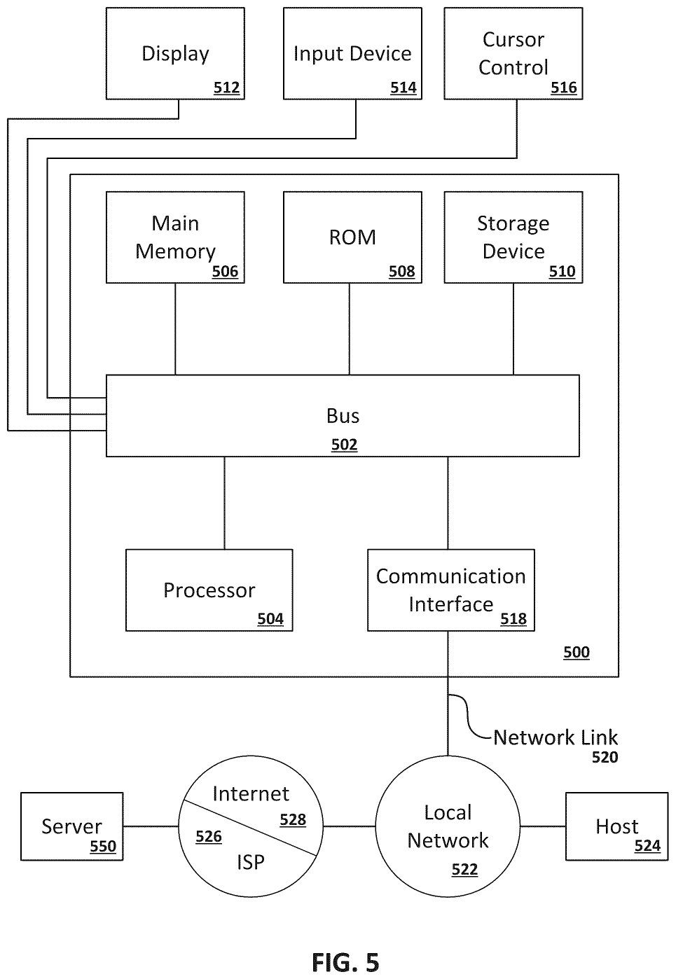

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read-only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware, and/or program logic that in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
accessing a first non-code representation of a first code module expressed in a first programming language;
parsing the first non-code representation to identify a nested data element of the first non-code representation, the nested data element representing a nested expression of the first code module;
executing a transformation technique to transform the nested data element, in the first non-code representation, to a first non-nested data element in the first non-code representation;
modifying the first non-code representation based on one or more attributes of a second programming language to generate a second non-code representation suitable for representing code modules in the second programming language;
generating a second code module based at least on the second non-code representation;
wherein the method is performed by at least one device including a hardware processor.

2. The method of claim 1, wherein modifying the first non-code representation based on the one or more attributes of the second programming language to generate the second non-code representation comprises:
converting the first non-nested data element to a second non-nested data element representing a second non-nested expression expressed in the second programming language;
wherein the second code module comprises the second non-nested expression expressed in the second programming language.

3. The method of claim 1, further comprising:
executing a static analysis of the nested data element to determine a functionality of the nested expression;
selecting the transformation technique, from a plurality of transformation techniques, based at least in part on the functionality.

4. The method of claim 3, wherein selecting the transformation technique based at least in part on the functionality comprises at least one of:
responsive to determining that the nested data element comprises a nested subquery, selecting a first transformation technique, from a pre-determined plurality of transformation techniques, that transforms nested subqueries into sequences of datasets that refer to one another;
responsive to determining that the nested data element comprises a correlated scalar subquery in the nested data element, selecting a second transformation technique, from the pre-determined plurality of transformation techniques, that transforms correlated scalar subqueries into scalar queries and correlated tables joined with the scalar queries; or
responsive to determining that the nested data element comprises a correlated subquery in the nested data element, selecting a third transformation technique, from the pre-determined plurality of transformation techniques, that transforms correlated subqueries into sets of separate datasets that are joined with one another using filter conditions.

5. The method of claim 3, further comprising:
training a machine learning model to select transformation techniques for transforming nested expressions to non-nested expressions;
generating an input element comprising the nested data element;
directing the input element to the machine learning model, wherein the machine learning model executes at least one inference comprising:
based at least in part on the functionality, selecting the transformation technique for transforming the nested data element to the first non-nested data element;
receiving, from the machine learning model, an output element generated by the machine learning model based at least in part on the transformation technique.

6. The method of claim 5, wherein at least one inference further comprises at least one of:
executing the transformation technique to transform the nested data element to the first non-nested data element;
modifying the first non-code representation based on the one or more attributes of the second programming language to generate the second non-code representation suitable for representing code modules in the second programming language; or
generating the second code module based at least on the second non-code representation.

7. The method of claim 1, wherein modifying the first non-code representation based on the one or more attributes of the second programming language to generate the second non-code representation comprises:
determining that a first data element type of a particular data element, in the first non-code representation, is unsupported in the second programming language;
replacing the particular data element with a different data element of a second data element type that is supported in the second programming language.

8. The method of claim 7, wherein the different data element, in the first non-code representation, is functionally equivalent to the particular data element.

9. The method of claim 1,
wherein the first programming language permits reusing a same operand name for different operands, and wherein the first code module comprises a first operand and a second operand;
wherein the method further comprises:
responsive to determining that the second programming language does not permit reusing the same operand name for different operands:
converting a first name of the first operand to a first modified name at least by applying a unique identifier to the first name;
wherein a second name of the second operand matches the first name, wherein the second name differs from the first modified name.

10. The method of claim 9,
wherein the first operand is located at a first layer of the nested data element and the second operand is located at a second layer of the nested data element,
wherein converting the first name of the first operand to the first modified name is further responsive to determining that a de-nesting operation will result in at least one nested expression having the same operand name for different operands.

11. The method of claim 10, wherein generating the second code module comprises:
generating, based at least in part on the first operand, a third operand comprising the first modified name;
generating, based at least in part on the second operand, a fourth operand comprising the second name.

12. The method of claim 1, further comprising:
identifying a first instance of an operand of the first code module, the first instance having a first name;
identifying a second instance of the operand, the second instance having a second name that differs from the first name;
converting the second name of the second instance to the first name.

13. The method of claim 1, further comprising:
transforming a first database application, for interacting with databases in the first programming language, into a second database application, for interacting with databases in the second programming language, wherein transforming the first database application into the second database application comprises:
selecting a first candidate expression from the first non-code representation;
determining that the first candidate expression is nested;
based on determining that the first candidate expression is nested, utilizing a first set of one or more transformation techniques to transform the first candidate expression from the first programming language to the second programming language;
selecting a second candidate expression from the first non-code representation;
determining that the second candidate expression is non-nested;
based on determining that the second candidate expression is non-nested, utilizing a second set of one or more transformation techniques to transform the second candidate expression from the first programming language to the second programming language.

14. The method of claim 13, further comprising:
combining the second code module with a general-purpose code module from the first database application.

15. The method of claim 14, further comprising:
modifying the general-purpose code module to reference at least one modified operand name of the second code module, the at least one modified operand name having been modified based on a naming convention.

16. The method of claim 1, wherein the transformation technique comprises one or more of:
a JOIN expression, a semi-JOIN expression, a UNION expression, a WITH expression, a CASE expression, a GROUP BY expression, or a DISTINCT expression.

17. The method of claim 1, wherein the transformation technique comprises:
utilizing an expression mapping table for converting the first non-nested data element corresponding to the first programming language to a second non-nested data element of representing a second non-nested expression expressed in the second programming language, the expression mapping table comprising a set of expressions written in the first programming language that are mapped to one or more functionally equivalent expressions written in the second programming language.

18. One or more non-transitory computer-readable media storing instructions that, when executed by one or more hardware processors, cause performance of operations comprising:
accessing a first non-code representation of a first code module expressed in a first programming language;
parsing the first non-code representation to identify a nested data element of the first non-code representation, the nested data element representing a nested expression of the first code module;
executing a transformation technique to transform the nested data element, in the first non-code representation, to a first non-nested data element in the first non-code representation;
modifying the first non-code representation based on one or more attributes of a second programming language to generate a second non-code representation suitable for representing code modules in the second programming language;
generating a second code module based at least on the second non-code representation.

19. The one or more non-transitory computer-readable media of claim 18,
wherein modifying the first non-code representation based on the one or more attributes of the second programming language to generate the second non-code representation comprises:
converting the first non-nested data element to a second non-nested data element representing a second non-nested expression expressed in the second programming language;
wherein the second code module comprises the second non-nested expression expressed in the second programming language.

20. A system comprising:
one or more hardware processors;
one or more non-transitory computer-readable media; and
program instructions stored on the one or more non-transitory computer-readable media that, when executed by the one or more hardware processors, cause the system to perform operations comprising:
accessing a first non-code representation of a first code module expressed in a first programming language;
parsing the first non-code representation to identify a nested data element of the first non-code representation, the nested data element representing a nested expression of the first code module;
executing a transformation technique to transform the nested data element, in the first non-code representation, to a first non-nested data element in the first non-code representation;
modifying the first non-code representation based on one or more attributes of a second programming language to generate a second non-code representation suitable for representing code modules in the second programming language;
generating a second code module based at least on the second non-code representation.
